(19) United States
(12) Patent Application Publication
(10) Pub. No.: US 2002/0052773 A1
(43) Pub. Date: May 2, 2002

(54) Worker management system

(76) Inventors: Michael Kraemer, Minnetonka, MN (US); Neil Dolinksy, Leopold (AU); Barbara Yau, Eagan, MN (US); David Lindberg, Bloomington, MN (US)

Correspondence Address: MERCHANT & GOULD PC, P.O. BOX 2903, MINNEAPOLIS, MN, 55402-0903, US

(21) Appl. No.: 09/974,486

(22) Filed: Oct. 9, 2001

Related U.S. Application Data
(60) Provisional application No. 60/238,597, filed on Oct. 6, 2000.

(51) Int. Cl. G06F 17/60

(52) U.S. Cl. 705/9

(57) ABSTRACT

A computer process, a computing system or as an article of manufacture for managing a web-based network of workers. The method has the steps of soliciting worker information from workers via the web-based network, soliciting a worker to staff a project based on the worker information, and assigning a performance rating to a worker based on worker performance on the project. The worker information includes a skill set rating.

### RELATED APPLICATIONS

This application claims priority to co-pending provisional U.S. patent application No. 60/238,597, filed Oct. 6, 2000, which is incorporated herein by reference in its entirety.

### TECHNICAL FIELD

The present invention relates to a method and system for managing workers. In another aspect, the invention relates to a method and system for managing workers through the internet.

### BACKGROUND OF THE INVENTION

In the past it has not been uncommon for an employee to work for the same company for over his or her entire career, lasting over 30-40 years. This enabled the employer and employee to develop a long-term relationship and share in the benefits associated with a long-term relationship. However, with the advent of just-in-time manufacturing it is increasingly common for employers to seek “just-in-time” workers in order to reduce costs and quickly meet demand. These workers are typically independent contractors and/or do not work permanently for the employer. Similarly, many workers want the flexibility of choosing when to work, what projects to work on, and for how much pay.

### SUMMARY OF THE INVENTION

Generally, the present invention relates to a worker management system. One embodiment is a method of managing a web-based network of workers. The method has the stepsof soliciting worker information from workers via the web-based network, soliciting a worker to staff a project based on the worker information, and assigning a performance rating to a worker based on worker performance on the project. The worker information includes a skill set rating. In other embodiments, a worker database can be queried based on project criteria and performance rating and workers that satisfy the query criteria are contacted through the web-based network.

In other embodiments, the workers are contacted with project criteria and the workers submit a worker application. The worker application is accepted based on a worker skill set rating and performance rating.

In other embodiments, workers apply for a project and the project criteria and worker information are compared. Workers are accepted or rejected based on this comparison.

The invention may be implemented as a computer process, a computing system or asan article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

The above summary of the present invention is not intended to describe each disclosed embodiment or every implementation of the present invention. The figures and the detailed description which follow more particularly exemplify these embodiments.

### BRIEF DESCRIPTION OF THE DRAWINGS

FIG. 1 illustrates one possible organization of a distributed computing system for implementing an embodiment of the present invention;

FIG. 2 illustrates computers according to one embodiment of the present invention;

FIG. 3 illustrates one embodiment of a worker management system according to the present invention;

FIG. 4 illustrates one embodiment of exemplary program modules according to the present invention;

FIG. 5 illustrates one embodiment of the database according to the present invention;

FIG. 6 illustrates a scheduling process implemented by the scheduling module according to one embodiment of the present invention;

FIG. 7 illustrates exemplary permissions for one embodiment of the worker management system according to the present invention;

FIG. 8 illustrates an exemplary report template according to one embodiment of the present invention;

FIG. 9 illustrates an exemplary web interface according to one embodiment of the present invention;

FIG. 10 illustrates an exemplary web interface according to one embodiment of the present invention;

FIG. 11 illustrates an exemplary web interface according to one embodiment of the present invention;

FIG. 12 illustrates another exemplary web interface according to one embodiment of the present invention;

FIG. 13 illustrates a referral bonus process implemented by the recruiting module according to one embodiment of the present invention; and

FIG. 14 illustrates a bonus process according to one embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

The present invention is believed to be applicable to methods and devices for managing workers. While the present invention is not so limited, an appreciation of various aspects of the invention will be gained through a discussion of the examples provided below.

One form of the present invention provides a system for project management of workers. In one embodiment described herein, the invention is a web-based project management system. In one embodiment, the management system can include modules relating to project announcement, recruitment, registration, project confirmation, screening, documentation, scheduling, performance rating, and community-building for workers. The system may manage workers such as technicians, plumbers, carpenters, designers, computer programmers, accountants, electricians, foodservices, marketing services, manufacturing services, secretaries, administrative assistants, and managers. The workers are typically independent workers in that they are not employees of the organization for which they are performing the service. Those skilled in the art will recognize that the list of types of workers described is non-exclusive.

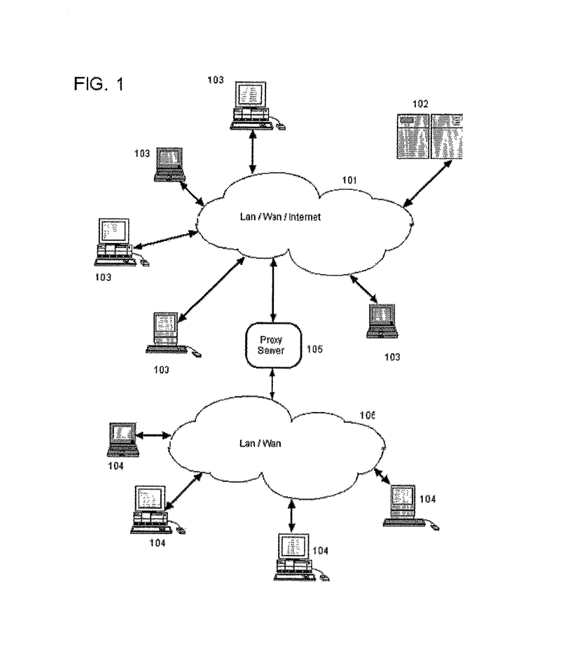

FIG. 1 illustrates one possible organization of a distributed computing system for implementing an embodiment of the present invention. The distributed computing system includes a plurality of computing systems connected together using a communications network. These computing systems include user workstations and laptop computers 103 directly connected to a wide area network (WAN) 101. Also connected to the WAN 101 is a plurality of server computers 102. In one possible embodiment of the present invention, the WAN 101 may be the Internet in which user computers 103 connected using a typical dial-up connection through an internet service provider (ISP).

Users of the network may also connect to the communications system using client computers 104 that are connected to a local area network (LAN) 106 in which the LAN 106 is connected to the internet 101 through a proxy server. In this arrangement, the client computers access resources located on the internet 101 by sending the request to the proxy server 105. The proxy server 105 in turn forwards the request to a destination on the internet. The response to this request is received by the proxy server 105 which forwards the request to the requesting client computer 104.

The server computers 102 receive these service requests from the user client computers 103, 104 and generate the appropriate responses. In the preferred embodiment, this communication is utilizing the standard http communications protocol. The responses generated and returned to the user client computers 103, 104 is typically in the form of a web page specified in HTML that may be displayed to the user utilizing a web browser such as MICROSOFT INTERNET EXPLORER or NETSCAPE NAVIGATOR.

The server computers 102 may store information such as information in a database or other electronic data. This data may also be stored in a distributed manner across one or more server computers 102. A web site can be programmed to access any of this data. Client computer 103 programs, such as browsers, allow a remote user to access the information stored on the web site and to navigate around the web. Generally, browsers employ a graphical user interface displayed on monitor 152 which allows the computer 103 to utilize a mouse 146 or other input device perform server 102 and data accession and navigation functions via the graphical interface. The server computer 102 can also be accessed via interactive voice response systems (IVR) or other known methods to provide an interface between humans and computers.

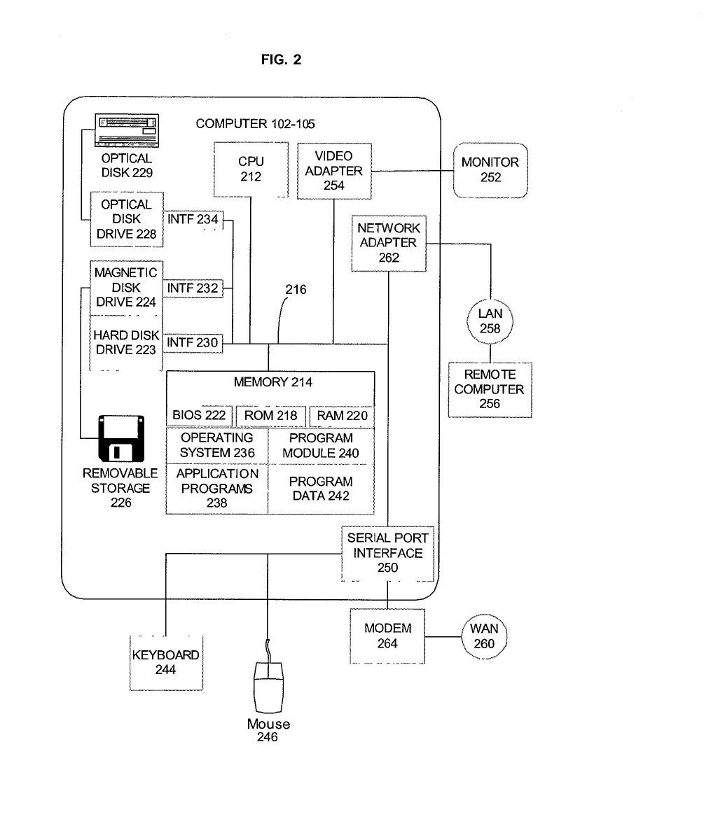

FIG. 2 illustrates computers 102, 103, 104 or 105 according to one embodiment of the present invention. An exemplary computing system for an embodiment of the invention includes a general purpose computing device in the form of a conventional computer system 102, 103, 104, or 105 including a processor unit 212, a system memory 214, and a system bus 216 that couples various system components including the system memory 214 to the processor unit 212. The system bus 216 may be any of several types of bus structures including a memory bus or memory controller, a peripheral bus and a local bus using any of a variety of bus architectures. The system memory includes read only memory (ROM) 218 and random access memory (RAM) 220. A basic input/output system 222 (BIOS), which contains basic routines that help transfer information between elements within the computer system 102, 103, 104, or 105, is stored in ROM 218.

The computer system 102, 103, 104, or 105 further includes a hard disk drive 223 for reading from and writing to a hard disk, a magnetic disk drive 224 for reading from or writing to a removable magnetic disk 226, and an optical disk drive 228 for reading from or writing to a removable optical disk 229 such as a CD ROM, DVD, or other optical media. The hard disk drive 223, magnetic disk drive 224, and optical disk drive 228 are connected to the system bus 216 by a hard disk drive interface 230, a magnetic disk drive interface 232, and an optical drive interface 234, respectively. The drives and their associated computer-readable media provide nonvolatile storage of computer readable instructions, data structures, programs, and other data for the computer system 102, 103, 104, or 105.

Although the exemplary environment described herein employs a hard disk 223, a removable magnetic disk 226, and a removable optical disk 229, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk 223, magnetic disk 226, optical disk 229, ROM 218 or RAM 220, including an operating system 236, one or more application programs 238, other program modules 240, and program data 242. A user may enter commands and information into the computer system 102, 103, 104, or 105, through input devices such as a keyboard 244 and mouse 246 or other pointing device. Examples of other input devices may include a microphone, joystick, game pad, satellite dish, and scanner. These and other input devices are often connected to the processing unit 212 through a serial port interface 250 that is coupled to the system bus 216. Nevertheless, these input devices also may be connected by other interfaces, such as a parallel port, game port, or a universal serial bus (USB). A monitor 252 or other type of display device is also connected to the system bus 216 via an interface, such as a video adapter 254. In addition to the monitor 252, computer systems typically include other peripheral output devices (not shown), such as speakers and printers.

The computer system 102, 103, 104, or 105, may operate in a networked environment using logical connections to one or more remote computers, such as a remote computer 256. The remote computer 256 may be a computer system, a server, a router, a network PC, a peer device or other common network node, and typically includes many or all of the elements described above relative to the computer system 102, 103, 104, or 105. The network connections include a local area network (LAN) 258 and a wide area network (WAN) 260. Such networking environments are commonplace in offices, enterprise-wide computer networks, intranets, and the Internet.

When used in a LAN networking environment, the computer system 102, 103, 104, or 105 is connected to the local network 258 through a network interface or adapter 262. When used in a WAN networking environment, the computer system 102, 103, 104, or 105 typically includes a modem 264 or other means for establishing communications over the wide area network 260, such as the Internet. The modem 264, which may be internal or external, is connected to the system bus 216 via the serial port interface 250. In a networked environment, program modules depicted relative to the computer system 102, 103, 104, or 105, or portions thereof, may be stored in the remote memory storage device. It will be appreciated that the network connections shown are exemplary, and other means of establishing a communications link between the computers may be used.

A computing device, such as computer system 102, 103, 104, or 105 typically includes at least some form of computer-readable media. Computer readable media can be any available media that can be accessed by the computer system 102, 103, 104, or 105. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computer system 102, 103, 104, or 105.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

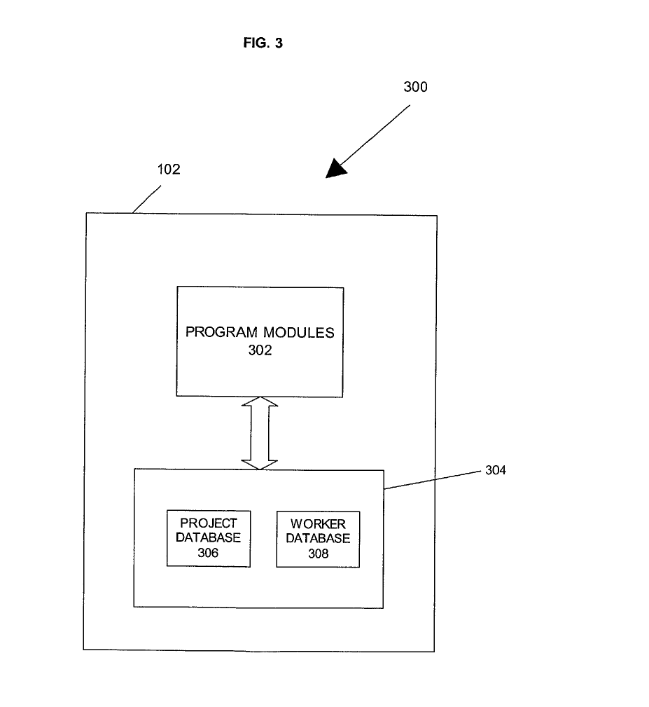

FIG. 3 illustrates one embodiment of a worker management system 300 according to the present invention. Worker management system 300 includes a server computer 102 that executes program modules 302 that interface to a database 304. The database 304 can include a project database 306 and a worker database 308. In other embodiments, the project database 306 and worker database 308 are integrated in one or more databases, as is known in the art. The database 304 can be accessed via a web interface, as is known to those skilled in the art.

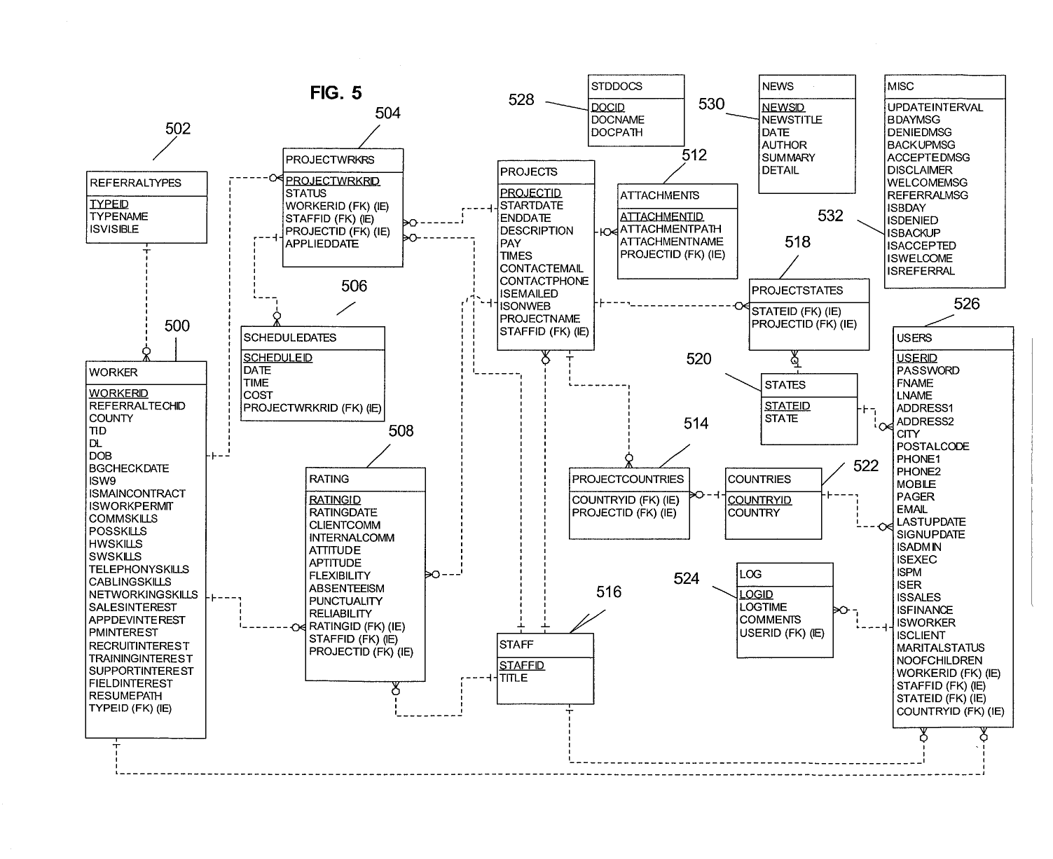

FIG. 5 illustrates one embodiment of the database 304 according to the present invention. The database 304 includes a worker table 500, a referraltypes table 502, projectwrkrs table 504, scheduledates table 506, rating table 508, projects table 510, attachments table 512, projectcountries table 514, staff table 516, projectstates table 518, states table 520, countries table 522, log table 524, users table 526, stddocs table 528, news table 530, and miscellaneous table 532. Each of the tables can have one or mores fields, as illustrated in FIG. 5.

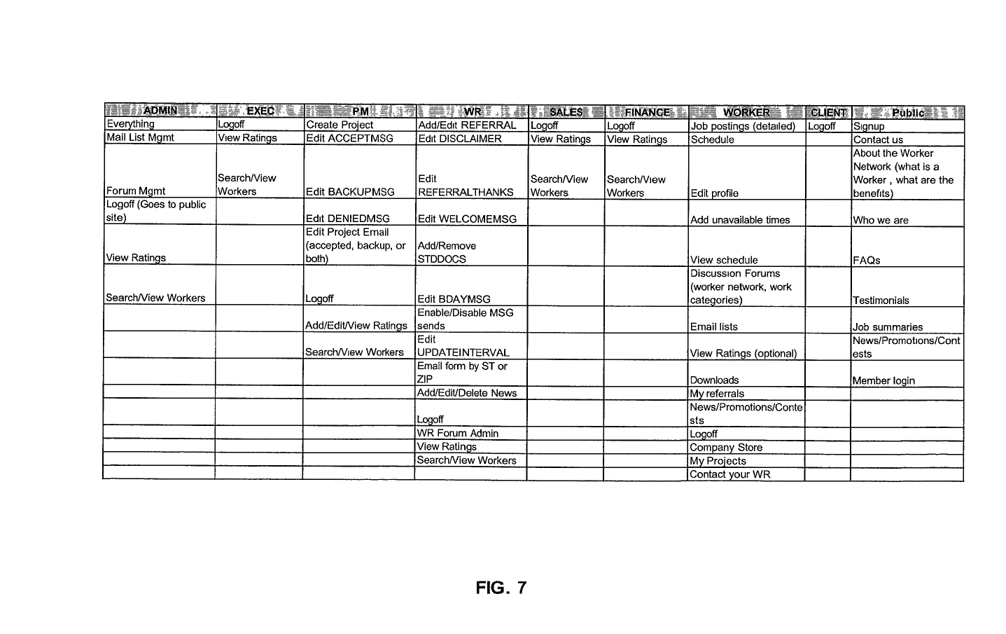

Users can be assigned permissions to access the worker management system 300. FIG. 7 illustrates exemplary permissions for one embodiment of the worker management system 300 according to the present invention. Users can be assigned to one or more classifications including administration, executive, project manager, worker referral, sales, finance, worker, client, or public.

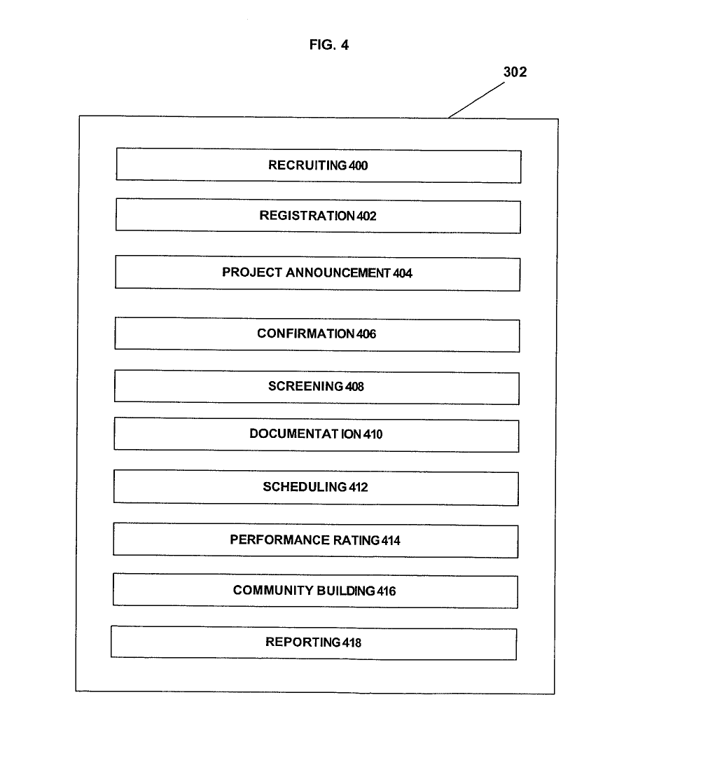

FIG. 4 illustrates one embodiment of exemplary program modules according to the present invention. The program modules 302 can include recruiting module 400, registration module 402, project announcement module 404, confirmation module 406, screening module 408, documentation module 410, scheduling module 412, performance rating module 414, community building module 416, and reporting module 418. In other embodiments, the worker management system 300 does not include all of these modules, or can include additional modules. As is known in the art, the functionality of these modules can be implemented in a variety of ways.

Recruiting module 400 directs the solicitation of workers. Workers can be solicited via advertisements placed in print and internet (i.e., web-based) publications. Prospective workers can be directed to register at the worker management system 300 website. Recruiting module 400 includes a referral module that monitors workers that are referred by registered workers. Existing workers can send a referral message through the worker management system 300 to a list of email addresses of prospective workers. The referral message includes links to the recruiting module of 400 of the worker management system 300 so that when the prospective worker registers at the worker management system 300 website the referring worker gets credit for the referral.

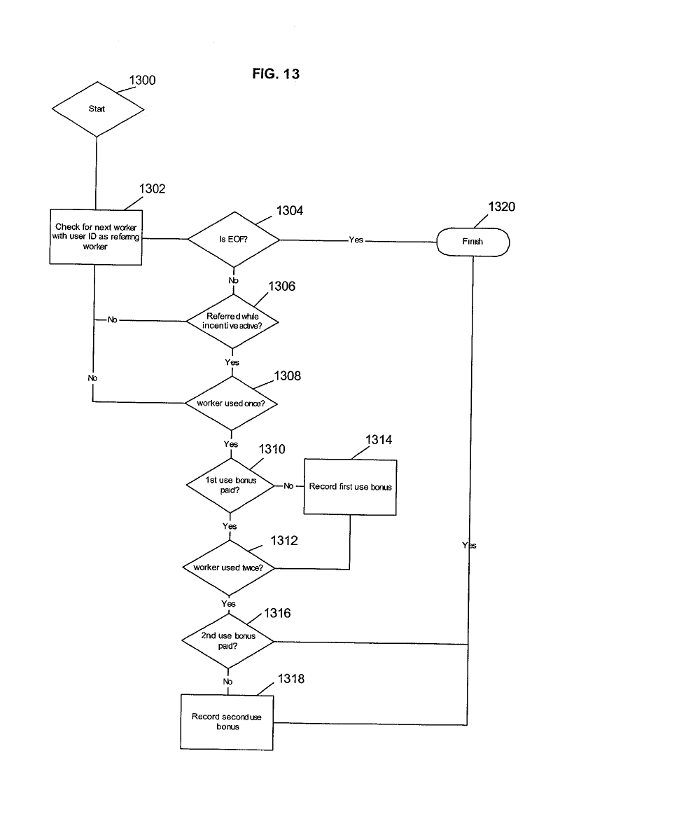

FIG. 13 illustrates a referral bonus process according to one embodiment of the present invention. The process can be implemented by the recruiting module 400. The recruiting module 400 can automatically, continually, and efficiently augment the population of the worker database 308. Start operation 1300 initiates the process. Check operation 1302 determines whether the next worker with user ID is a referring worker. If so, end of file operation determines if the recruiting module reached the end of file. If so, then the process finishes at finish operation 1320. If not end of file, or if the next user ID is not a referring worker, then incentive operation 1306 determines if the worker was referred while an incentive was active. An incentive is active if the second use of a referred worker has not been reached, and a referral bonus may still be payable. If so, first prior use operation 1308 determines if the worker was used once. If so, first bonus operation 1310 determines if the first use bonus was paid. If so, then second prior use operation 1312 determines if the worker was used a second time; otherwise, the first use bonus is recorded in operation 1314. If the operation 1312 determines that a worker was not used twice, then operation 1314 records the bonus; otherwise, second bonus operation 1316 determines if the second use bonuswas paid. If not, then operation 1318 records the second use bonus.

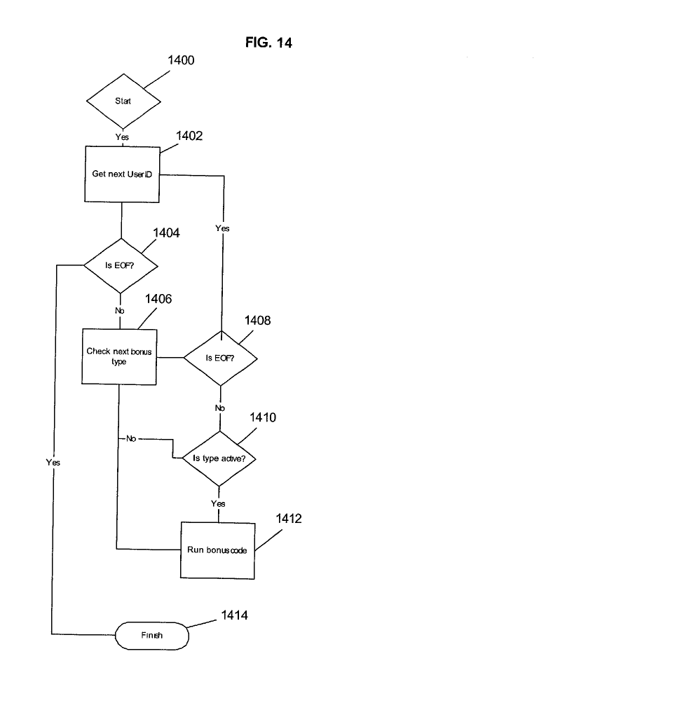

FIG. 14 illustrates a bonus process according to one embodiment of the present invention. Start operation 1400 initiates the process. UserID operation 1402 gets the next UserID. End of file operation 1404 determines if an end of file is reached. If so, the process terminates at finish process 1414. Otherwise, type process 1406 determines the next bonus type. Bonus types caninclude referral, performance (eg., complete tasks timely manner, worker stays through the duration of the project, based on ratings), or a bonus based on other criteria End of file operation 1408 determines if an end of file is reached. If so, UserID operation 1402 gets the next UserID. Otherwise, active operation determines whether the bonus is active. A bonus is active until a specified criteria has been reached. If the bonus is active, run operation 1412 runs the bonus code and then type process 1406 determines the next bonus type. Otherwise, type process 1406 determines the next bonus type. The bonus process can allow the efficient processing of bonuses serially at periodic intervals (e.g., monthly).

Registration module 402 manages the registration of workers at the worker management system 300 website. A prospective worker is requested to provide personal information, which can include name, address, telephone number, email address, personal identification numbers (driver's license number, social security number, etc.), and self-assessed skill set ratings. Upon submission of the registration information to the registration module 402, the worker management system 300 provides the registered worker with a unique user identification number and password for future access to the worker management system 300 website. In one embodiment, the registration module 402 provides a web based registration form to receive information from the worker. A resume, certification, or diploma could be submitted with the form. An exemplary registration form can include the following fields:

First Name*

Last Name*

How Hear About Us?

Address1*

Address2

City*

County

Postal Code*

State*

Country*

Phone1 *

Phone2

Mobile Phone

Pager

Email*

Referred by [worker's ID #]

SSN# or Tax ID#

Driver License #

Date of Birth

Background check

W9

Main Contract

Work Permit

The registration form can also solicit a skill set rating (self-evaluation) from the worker. In the embodiment illustrated below, the experience criteria relates primarily to technical experience. In other embodiments, other skills and experiences can be rated. In one embodiment, the workers can be requested to rate themselves on the scale of 1 to 5 (with ‘5’ being the best) as to the following criteria:

Communication skills

Field Service

Support

Training

Recruiting

Project Management

Application Development

Prospecting

ATM (Automated Teller Machines) experience

Cabling

Communication

Compaq experience

Construction

Datatec experience

Dell experience

Diebold experience

DSL experience

EDS experience

Electrical - High Voltage

Electrical - Low Voltage

Entex experience

Fujitsu Experience

Hardware

Hewlett Packard

IBM experience

Indyme experience

Kyrus experience

NCR experience

NEC experience

Networking

Norwest Bank experience

Point of Sale

R2 experience

RF experience

RSS experience

Sales experience

Satellite dish experience

Siemens experience

Software:

Symbol experience

Telephony

Unisys experience

Wells Fargo experience

Wincor-Nixdorf experience

Cisco - CCDA

Cisco - CCDP

Cisco - CCIE Design

Cisco - CCIE Routing and Switching

Cisco -CCNA

Cisco - CCNP

Lucent Certification

MCSE Windows 2000

MCSE Windows NT

The skill set rating can include customer ratings (requesting experience with a particular customer) or information relating to whether a recognized certification (such as a diploma or professional affiliation) has been obtained in an area. Other criteria can be used depending on the needs of a particular project. In other embodiments, the level of interest, and whether or not a worker has experience or knowledge, can be rated.

Upon submission of the registration form, the registration module 402 sends the worker a confirmation email and assigns the worker a unique number or code that can be used as a logon ID for the worker management system web site. The confirmation email can provide links to the required documentation, such as a W-9 form, independent contractor agreement, and background check form. Forms may be printed, signed, and mailed or emailed to central office. A generic password can also be sent to the worker so that the worker will be required to change thepassword in the first login. Alternatively, the worker can specify a password during registration.

The registration module 402 can include an update module to keep the information provided current and to solicit additional information. For example, the update module can solicit information from the worker relating to additional skill ratings (e.g., has the worker updated Windows NT certification to Windows 2000 certification) or experience with a particular customer. The update module can ask the worker to confirm their information every six months, or another period of time, or based on customer needs. In one embodiment, based on the worker's last information change date or last confirmation date, a screen will appear after they login. Worker personal information will be available on the screen and the worker will have an “All info is correct” (Yes/No) option. If the response is “Yes,” then the information change date field in the database is updated and a flag is set to ask the same question in sixmonths. If the response is “No,” the worker can be provided with an edit screen to update their personal info. After the revised information is submitted, the information change date field in the database is updated and a flag is set to ask the same question in six months. In some embodiments, the database can track the historical changes to the data.

Project announcement module 404 provides the project needs to the workers. In one embodiment, details of project needs are posted to the worker management system web site. Information regarding scope, price, geography, and skill set are included. Registered workers may apply for the project by selecting a reply “button” that appears after clicking on the project description's hyperlink.

In other embodiments, the project announcement module 404 includes a global search tool wherein the worker database 306 can be queried based on worker selection criteria. The worker criteria can include geography, skill set, and performance rating. User or customer-specified criteria can also be recorded in the worker database and queried. The worker database can generate a list of workers that fit the specified criteria. The worker management system can send an email to each of the workers listed that describes the project needs and solicits a response. Upon receipt of a positive response from the workers, they can be selectively chosen to work on a project.

The project announcement module can post the project to the worker management system website or send an email to the workers. The following fields can be included in an exemplary electronic project specification form that can be provided to the website or via email:

Name (open text field)

ID # (generated by the system)

Dates (MM/DD/YY, MM/DD/YY, . . . or MM/DD/YY - MM/DD/YY)

Locations (multiple states or all)

Description (open text field)

Pay (open text field)

Times (open text field)

Email address

Phone # (open text field)

Attachments (browse and attach a document and give it a name):

Project manual

Scope of work document

Training documents

Tests

Addendum

Status: hiring, staffed, or closed.

When the form is posted to the worker management system website, the following documents can be attached to every project detail posting for easy access: W9, Main Contract, and Background Check. After the project announcement form is filled in by the project manager, it can be posted to the worker management system website (default) or be sent to selected workers. The workers can be selected via a query on the worker database or by an automated query that matches fields from the project announcement form with corresponding information about the workers from the worker database.

After the project announcement form is submitted by the project manager, the worker management system 300 can post the project to the website. The project posted to the website typically will include a partial listing of the fields associated with the project announcement. Exemplary fields for a partial listing include the project name, Name, Dates, Locations, Description, and Pay. A link can be provided requiring a Worker ID to view the Pay information.

If project announcement is to be sent to workers, then a query form can be provided to select the ideal workers from the worker database 308. The query form will typically have the following fields: State, Zip (with wild card i.e. 554*), skill set rating for the skills of interest for the project, and the desired performance ratings. The result of the query can be a list of workers with the name, state, and a link to additional information on the worker, such as schedule information. The project manager can exclude some workers from the list. The project announcement module will generate an email to send to the workers on the list. The email can include project name, dates, locations, description, and pay. A link can be provided requiring a Worker ID to view the pay information.

Confirmation module 406 confirms that a worker has been chosen to work on a project. In one embodiment, when a worker has applied for a project, either via response to a project posting on the worker management system 300 website, or via a response to a global search email, the worker management system 300 can ‘Accept,’ ‘Backup,’ or ‘Reject’ a worker. Upon selecting ‘Accept’ for a worker, an email can be sent to the worker confirming a place on the project team. Upon selecting ‘Backup’ for a worker, an email can be sent to the worker confirming a place on the project team's backup list. Upon selecting ‘Reject’ for a worker, an email is sent to the worker, noting receipt of the application, and rejection of the application. The confirmation module can provide detailed information on the worker from the worker database 306. Confirmation module 406 interfaces to the scheduling module 412. The confirmation module 406 provides worker information to the scheduling module 412. The scheduling module 412 provides the project ID#, project manager name, date, time, cost and other information to the confirmation module 406.

Screening module 408 can optionally perform a background check on a worker applicant. This background check can be performed at the time the worker registers, at the time the worker is selected to work on a project, or at another time. The background check can include checking for a criminal record, checking references provided by the worker, or other verification of the suitability of a worker for a project.

Documentation module 410 manages documents associated with the worker and the project. These documents can include tax documents, verification documents, or other documents, including agreements and disclaimers. The documents can be posted to worker management system 300 website where the worker may download, print, sign and return the documents. In other embodiments, the worker can authenticate the documents via a digital signature or other method.

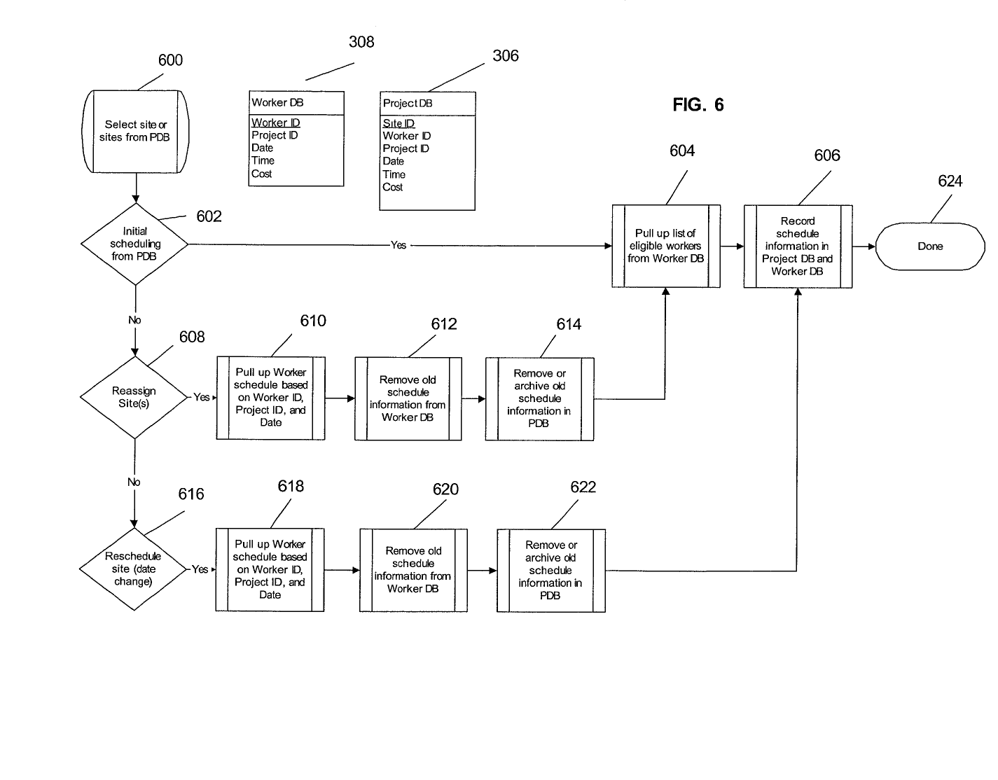

Scheduling module 412 interfaces the project database 306 and worker database 308 to schedule workers on projects. FIG. 6 illustrates a scheduling process implemented by the scheduling module 412 according to one embodiment of the present invention. Select operation 600 selects a site or sites from the project database 306. Decision operation 602 determines whether it is an initial scheduling request. If so, worker retrieval operation 604 provides a list of the eligible workers from the worker database 308. Schedule operation 606 records the schedule information in the project database 306 and the worker database 308 and the operation is complete at block 624.

If an initial scheduling request is not provided to the scheduling module, reassignment operation 608 determines whether a site reassignment is requested. If so, retrieval operation 610 pulls up the worker schedule based on worker ID, project ID, date, or other criteria. Removal operation 612 removes the old schedule information from the worker database 308. Archive operation 614 removes or archives old schedule information in the project database 306. Control is passed to the worker retrieval operation 604.

If an assignment is not requested, reschedule operation 616 determines whether a site rescheduling is requested. If so, retrieval operation 618 pulls up the worker schedule based on worker ID, project ID, date, or other criteria. Removal operation 620 removes the old schedule information from the worker database 308. Archive operation 622 removes or archives old schedule information in the project database 306. Control is passed to the schedule operation 606.

Performance rating module 414 assigns a performance rating to a worker. In one embodiment, upon completion of a specific project, a performance rating for a worker can be entered into the worker database 306. The rating can be based on a numerical or qualitative scale. An aggregate overall performance rating can be maintained for each worker. Tabulation of ratings can incorporate an averaging algorithm such that the performance rating reflects an average score for each e-Tech, resulting from the combined performance ratings entered by all of Host's staff over time. Other rating systems are possible, including those that based on known statistical analysis methods to ensure the accuracy and reliability of the data. In one such method, the lowest and highest ratings are dropped from the averaging algorithm. In other embodiments a weighting algorithm can be applied which can weight the ratings based on project criteria, historical trends, or other external factors. In other embodiments, recent ratings are weighted heavier than past ratings.

The performance rating module can manage text-based commentary that can be added to a workers personal profile. This commentary can be selectively viewed by authorized personnel. In other embodiments, the performance rating module 414 provides a report card to a worker via the website. This report card can provide ratings for a specific project or historical ratings for several projects.

In yet other embodiments, ratings are maintained with respect to individual criteria. This criteria can include aspects of the worker's personal work habits. Worker habits can include client communication, internal communication, professionalism, attitude, aptitude, flexibility, absenteeism, reliability, and punctuality.

Community building module 416 provides a worker interface to promote community, loyalty, and morale. The workers are typically independent contractors and thus are not subject to control by the worker management system and are typically not bound, directly or indirectly, to devote their energies and talents to the service of projects exclusively for the benefit of the worker management system. In order to maintain a sense of community and loyalty, as well as provide incentives for continued interest in working on projects coordinated by the worker management system 300, various channels for building a sense of community among the workers are provided. These channels can include discussion forums, chat rooms, news postings, contests, promotions, stores, or electronic news updates. An email forum can allow emails to be sent to workers living in a specific zip code with wild card (e.g., 554*) or other identified group of workers in the database. The email forum can include known “mail merge” features to personalize the mailing. The community building module 416 can manage worker email groups so that workers interested in particular subjects can receive emails or other communications related to the subject. A community forum can be provided through a threaded bulletin board to allow workers to vent complaints, compliments, inquiries, etc. The community building module 416 allows administrators of the worker management system 300 to interface with the workers through queries, messages, hosting ongoing dialogue, and other means. A “company store” can be provided that sells items at a discount. The worker management system 300 can provide modules and interfaces to cross-sell products or services to the workers, especially where such products or services complement the work they do. Examples include workers compensation insurance, travel services, tools, equipment, and training.

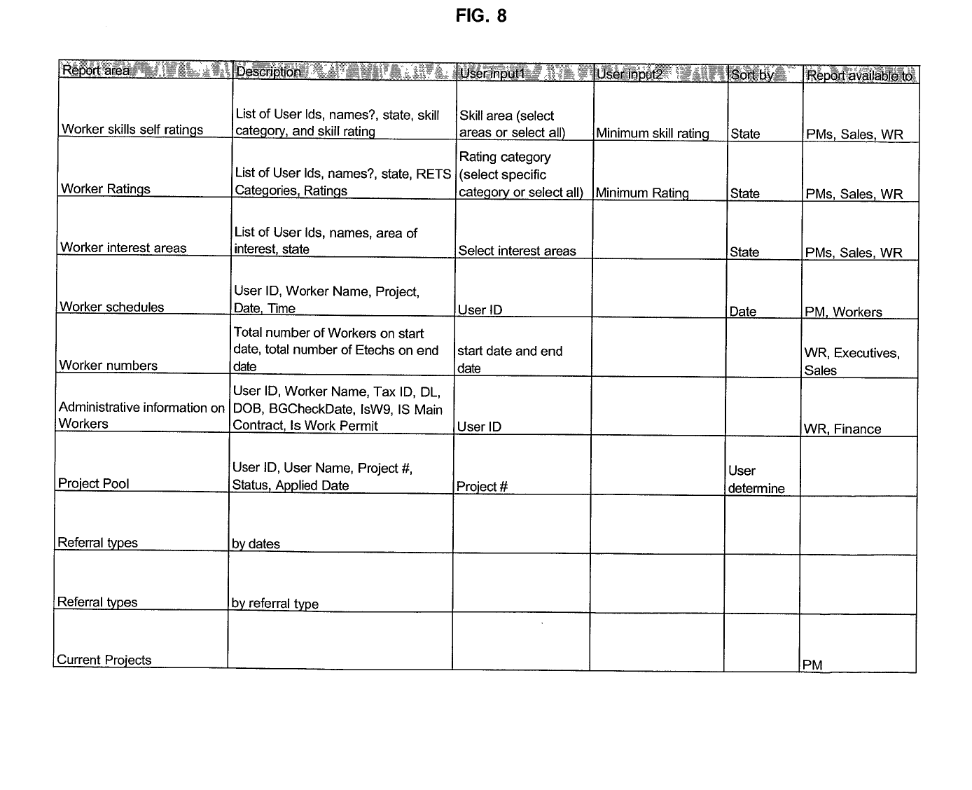

Reporting module 418 can provide a pre-specified and user defined reports. The reports can provide information related to the information stored in the project database 306 and worker database 308, as is known in the art. FIG. 8 illustrates an exemplary report template according to one embodiment of the present invention. The reporting module 418 provides an interface to monitor workers and projects. The reporting module 418 can also provide real time information relating to what information the worker management system 300 has received. The information can include information related to whether users have entered comments into the database 304, whether ratings have been entered into the worker database 308, or requested information.

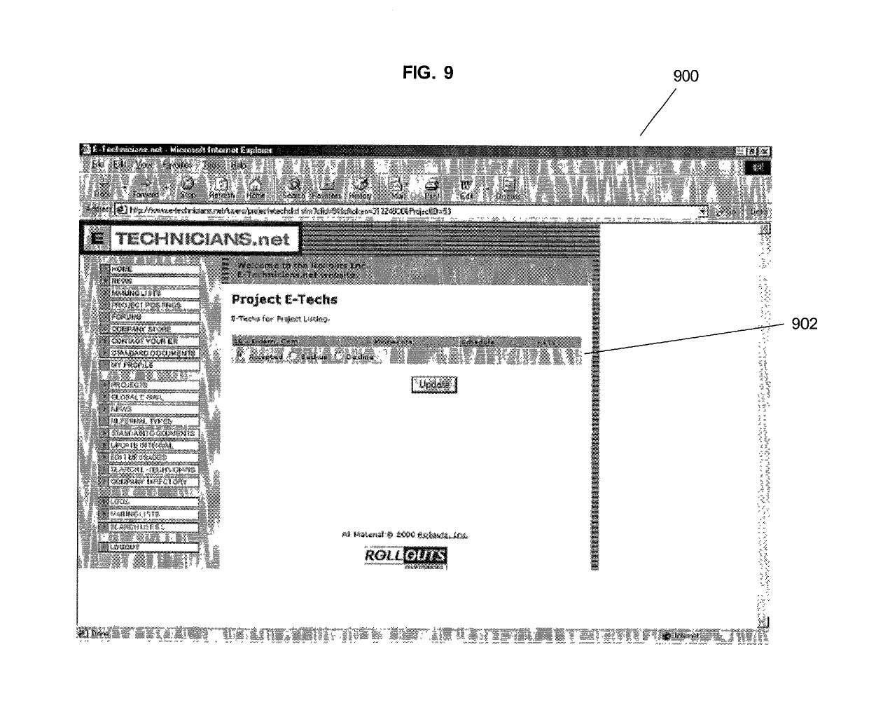

FIG. 9 illustrates an exemplary web interface according to one embodiment of the present invention. Web page 900 provides an interface to the confirmation module 406. Web page 900 includes table 902 for indicating to the confirmation module 406 whether a worker is accepted, declined, or relegated to back-up status.

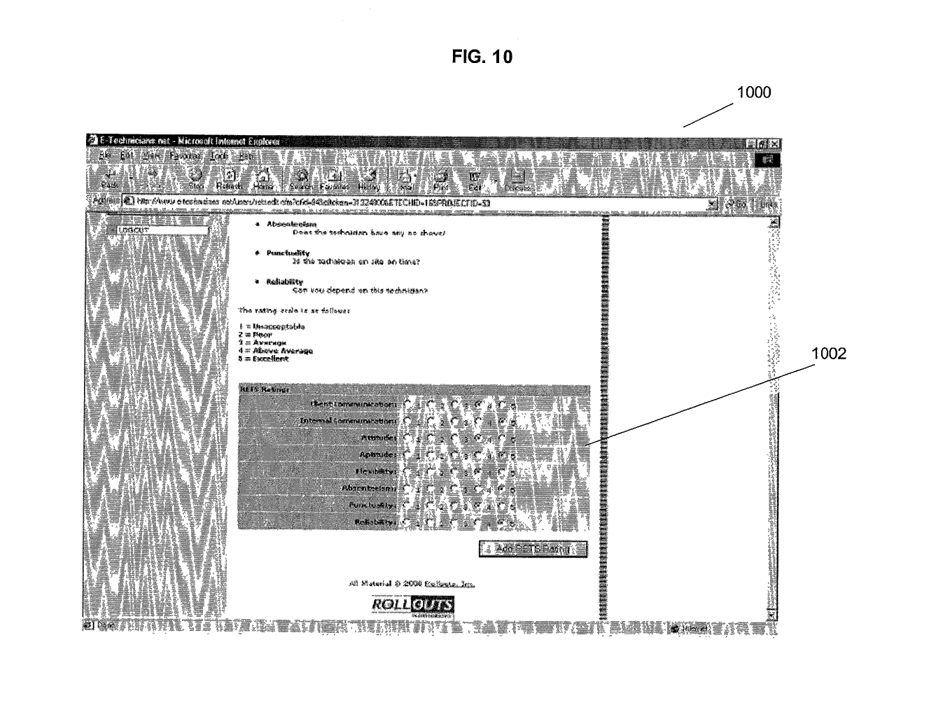

FIG. 10 illustrates an exemplary web interface according to one embodiment of the present invention. Web page 1000 provides an interface to the performance rating module 414. Web page 1000 includes table 1002 for indicating to the performance rating module 414 a workers performance in the areas of client communication, internal communication, attitude, aptitude, flexibility, absenteeism, punctuality, and reliability.

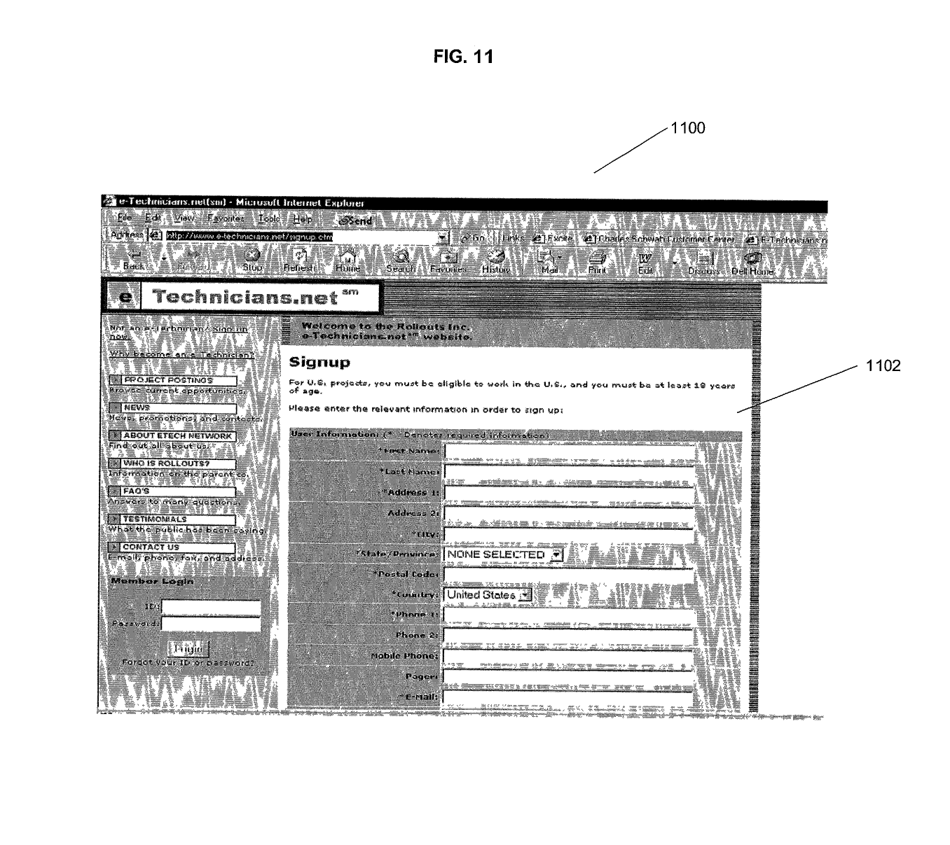

FIG. 11 illustrates an exemplary web interface according to one embodiment of the present invention. Web page 1100 provides an interface to the registration module 402. Web page 1100 includes table 1102 for indicating to the registration module 402 information relating to a worker.

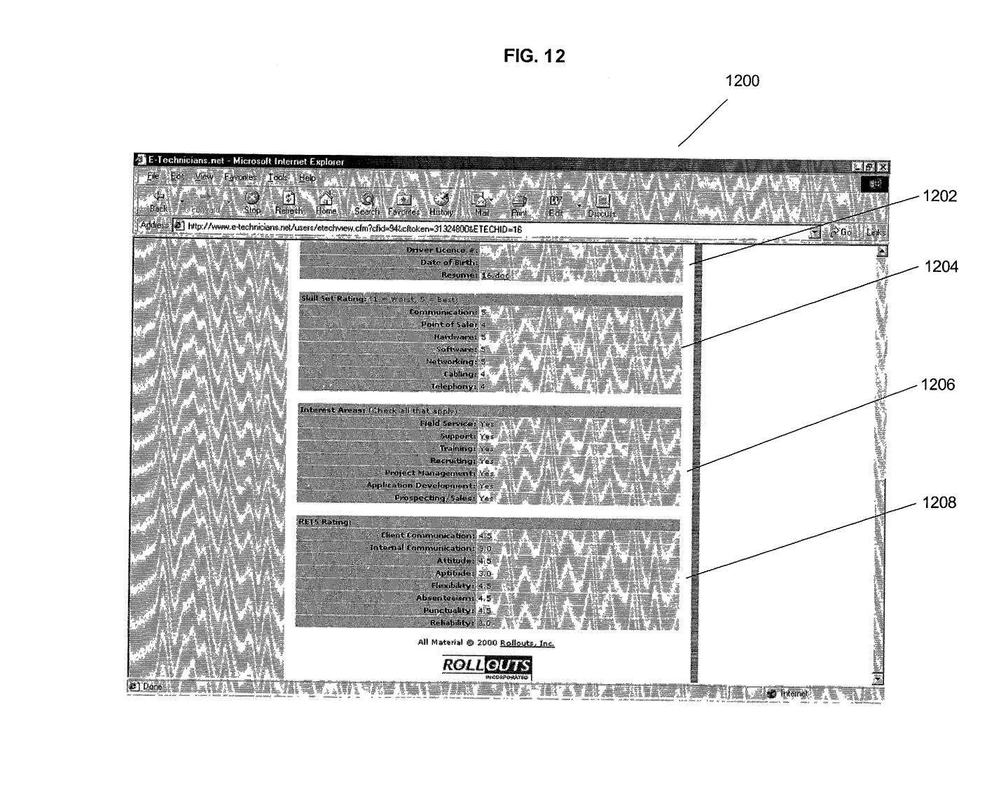

FIG. 12 illustrates another exemplary web interface according to one embodiment of the present invention. Web page 1200 provides interface tables to the worker database 308. These tables can include a skill set rating table 1204, an interest area table 1206, and a table 1208 for indicating a rating for an individual worker.

Thus, the present invention is presently embodied as a method, apparatus, computer program product, or computer readable media encoding a computer program for managing workers.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A method of managing a web-based network of workers, the method comprising:
soliciting worker information from workers via the web-based network, wherein the worker information includes a skill set rating;
soliciting a worker to staff a project based on the worker information; and
assigning a performance rating to a worker based on worker performance on the project.

2. The method of claim 1, wherein the soliciting worker information step comprises the step of recruiting workers through a referral bonus plan.

3. The method of claim 1, wherein the soliciting worker information step comprises the step of recruiting workers through print media.

4. The method of claim 1, wherein the worker information further comprises contact information, worker task preferences, and geographical location.

5. The method of claim 1, wherein the skill set rating comprises a rating based on experience, interest, or certifications.

6. The method of claim 1, wherein project criteria define a project, wherein worker information is stored in a worker database, wherein the soliciting a worker to staff a project step further comprises the steps of:
querying the worker database for matches based on project criteria and performance rating; and
contacting the workers that satisfy the query criteria through the web-based network.

7. The method of claim 1, wherein project criteria define a project, wherein the soliciting a worker to staff a project step further comprises the steps of:
contacting workers via the web-based network with project criteria;
receiving via the web-based network a worker application identifying a worker interested in the project; and
accepting application from worker based on skill set rating and performance rating.

8. The method of claim 1, wherein project criteria define a project, wherein the soliciting a worker to staff a project step further comprises the steps of:
contacting workers via the web-based network with project criteria;
receiving via the web-based network a worker application identifying an interested worker for the project;
comparing the project criteria and worker information for the interested worker; and
accepting or rejecting the interested worker based on the comparing step.

9. The method of claim 8, further comprising the step of automatically sending an email to the interested worker based on accepting or rejecting the interested worker.

10. The method of claim 1, further comprising the step of scheduling a worker on a project

11. The method of claim 10, further comprising the step of monitoring a worker on a project.

12. A system for managing a web-based network of workers, the system comprising:
a worker information module soliciting worker information from workers via the web-based network, wherein the worker information includes a skill set rating;
a project module soliciting a worker to staff a project based on the worker information; and
a rating module assigning a performance rating to a worker based on worker performance on the project.

13. The system of claim 12, wherein the worker information module recruits workers through a referral bonus plan.

14. The system of claim 12, wherein the worker information module recruits workers through print media.

15. The system of claim 12, wherein the worker information comprises contact information, worker task preferences, and geographical location.

16. The system of claim 12, wherein the skill set rating comprises a rating based on experience, interest, or certifications.

17. The system of claim 12, wherein project criteria define a project, wherein worker information is stored in a worker database, wherein the project module further comprises:
query module querying the worker database for matches based on project criteria and performance rating; and
communication module contacting the workers that satisfy the query criteria through the web-based network.

18. The system of claim 12, wherein project criteria define a project, wherein the project module further comprises:
communication module contacting workers via the web-based network with project criteria, receiving via the web-based network a worker application identifying a worker interested in the project, and accepting application from worker based on skill set rating and performance rating.

19. The system of claim 12, wherein project criteria define a project, wherein the project module further comprises:
communication module contacting workers via the web-based network with project criteria, receiving via the web-based network a worker application identifying an interested worker for the project, comparing the project criteria and worker information for the interested worker, and accepting or rejecting the interested worker based on comparing the project criteria and worker information.

20. The system of claim 19, further comprising a confirmation module automatically sending an email to the interested worker based on accepting or rejecting the interested worker.

21. The system of claim 20, further comprising a scheduling module scheduling a worker on a project.

22. The system of claim 20, further comprising a monitoring module monitoring a worker on a project.

23. A computer program product readable by a computing system and encoding a computer program of instructions for executing a computer process for managing a web-based network of workers, said computer process comprising:
soliciting worker information from workers via the web-based network, wherein the worker information includes a skill set rating;
soliciting a worker to staff a project based on the worker information; and
assigning a performance rating to a worker based on worker performance on the project.

24. The computer program product of claim 23, wherein the soliciting worker information step comprises the step of recruiting workers through a referral bonus plan.

25. The computer program product of claim 23, wherein the soliciting worker information step comprises the step of recruiting workers through print media.

26. The computer program product of claim 23, wherein the worker information further comprises contact information, worker task preferences, and geographical location.

27. The computer program product of claim 23, wherein the skill set rating comprises a rating based on experience, interest, or certifications.

28. The computer program product of claim 23, wherein project criteria define a project, wherein worker information is stored in a worker database, wherein the soliciting a worker to staff a project step further comprises the steps of:
querying the worker database for matches based on project criteria and performance rating; and
contacting the workers that satisfy the query criteria through the web-based network.

29. The computer program product of claim 23, wherein project criteria define a project, wherein the soliciting a worker to staff a project step further comprises the steps of:
contacting workers via the web-based network with project criteria;
receiving via the web-based network a worker application identifying a worker interested in the project; and
accepting application from worker based on skill set rating and performance rating.

30. The computer program product of claim 23, wherein project criteria define a project, wherein the soliciting a worker to staff a project step further comprises the steps of:
contacting workers via the web-based network with project criteria;
receiving via the web-based network a worker application identifying an interested worker for the project;
comparing the project criteria and worker information for the interested worker; and
accepting or rejecting the interested worker based on the comparing step.

31. The computer program product of claim 30, further comprising the step of automatically sending an email to the interested worker based on accepting or rejecting the interested worker.

32. The computer program product of claim 23, further comprising the step of scheduling a worker on a project.

33. The computer program product of claim 32, further comprising the step of monitoring a worker on a project.
